(19) United States
(12) Patent Application Publication
(10) Pub. No.: US 2005/0069604 A1
(43) Pub. Date: Mar. 31, 2005

(54) Hot runner component heater having thermal sprayed resistive element

(75) Inventors: Iosif Pisman, Wheeling, IL (US); Daryl E. Crawmer, Fall River, WI (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Fast Heat, Inc., Elmhurst, IL (US)

(21) Appl. No.: 10/871,788

(22) Filed: Jun. 18, 2004

Related U.S. Application Data
(60) Provisional application No. 60/480,554, filed on Jun. 20, 2003.

(51) Int. Cl. B29C 45/20; H05B 3/00

(52) U.S. Cl. 425/549; 29/611; 29/620

(57) ABSTRACT

A hot runner component for heating and directing fluid material of a melt stream to a mold cavity is provided. The hot runner component includes a body having a fluid passageway therein for conveying the melt stream and a heater for heating the melt stream as the melt stream passes through the fluid passageway of the body. The heater includes a core arranged in surrounding relation to the fluid passageway of the body, a thermally-sprayed dielectric substrate layer on the core and a thermally-sprayed electrical resistance element layer overlying the dielectric substrate layer. The resistance element layer forms a discrete pattern. The heater further includes a thermally sprayed dielectric overlay layer that overlies a substantial portion of the resistance element layer.

### FIELD OF THE INVENTION

This invention pertains generally to hot runner components for an injection molding apparatus, and more particularly, to a heater for such a hot runner component.

### BACKGROUND OF THE INVENTION

Hot runner systems are used in injection molding machines for feeding a fluid plastic material or melt stream that is maintained at an elevated temperature to a mold cavity. One component of a hot runner system is a hot runner bushing or nozzle. A hot runner bushing or nozzle generally consists of a body defining a central passageway for conveying the fluid plastic material to a mold cavity through a gate.

To maintain the fluid plastic material at an elevated temperature, a hot runner bushing also includes an electric heater that generally consists of a resistance wire that is helically wound around the central passageway. This resistance wire can be wound directly on the nozzle or bushing body or be incorporated into a separate sleeve that can be positioned over the body. In either case, the resistance wire is encased in an outer shell with an electrically insulative powder, such as magnesium oxide, interposed in surrounding relation about the resistance wire. To ensure efficient thermal conductivity, the nozzle or bushing body and heater are swaged so as to compact the powder and thereby fill all the voids around the resistance wire.

Unfortunately, conventional hot runner bushing heaters are labor intensive to manufacture. Moreover, manufacturing these heaters requires multiple steps including winding the resistance wire, filling the heater with the electrically insulative powder and swaging the heater. As a result, conventional hot runner bushing heaters are time-consuming and expensive to manufacture. Another problem with conventional hot runner bushing heaters is that they have a relatively large cross-sectional area. This makes them difficult to use with relative small hot runner components. Additionally, the relatively large size of the heaters makes them more susceptible to condensation and moisture.

### BRIEF SUMMARY OF THE INVENTION

The invention provides a hot runner component for heating and directing fluid material of a melt stream to a mold cavity. The hot runner component includes a body having a fluid passageway therein for conveying the melt stream and a heater for heating the melt stream as the melt stream passes through the fluid passageway of the body. The heater includes a core arranged in surrounding relation to the fluid passageway of the body, a thermally-sprayed dielectric substrate layer on the core and a thermally-sprayed electrical resistance element layer overlying the dielectric substrate layer. The resistance element layer forms a discrete pattern. The heater further includes a thermally sprayed dielectric overlay layer that overlies a substantial portion of the resistance element layer.

In an alternative embodiment, the invention provides a method for making a hot runner component for heating and directing fluid material of a melt stream. The inventive method includes the step of thermally spraying a dielectric powder material onto an outer surface of a heater core to form a dielectric substrate layer. An electric resistance powder material is thermally sprayed onto the dielectric substrate layer to form an electric resistance element layer with the electric resistance element layer being formed in a discrete pattern. A dielectric powder material is thermally sprayed over a substantial portion of the resistance element layer to form an dielectric overlay layer. The heater core is then arranged in surrounding relation to a fluid passageway extending through a hot runner component body.

### BRIEF DESCRIPTION OF THE DRAWINGS

FIG. 1 is a an exploded side elevation view of a hot runner bushing according to the present invention.

FIG. 2 is a front elevation view of the core of the heater of FIG. 1 showing diagrammatically the application of the thermally sprayed heater components.

FIG. 3 is a side elevation view of the heater of FIG. 1 after application of the thermally sprayed resistance element layer.

FIG. 4 is a side elevation view of the assembled hot runner bushing of FIG. 1 except for the tip.

### DETAILED DESCRIPTION OF THE INVENTION

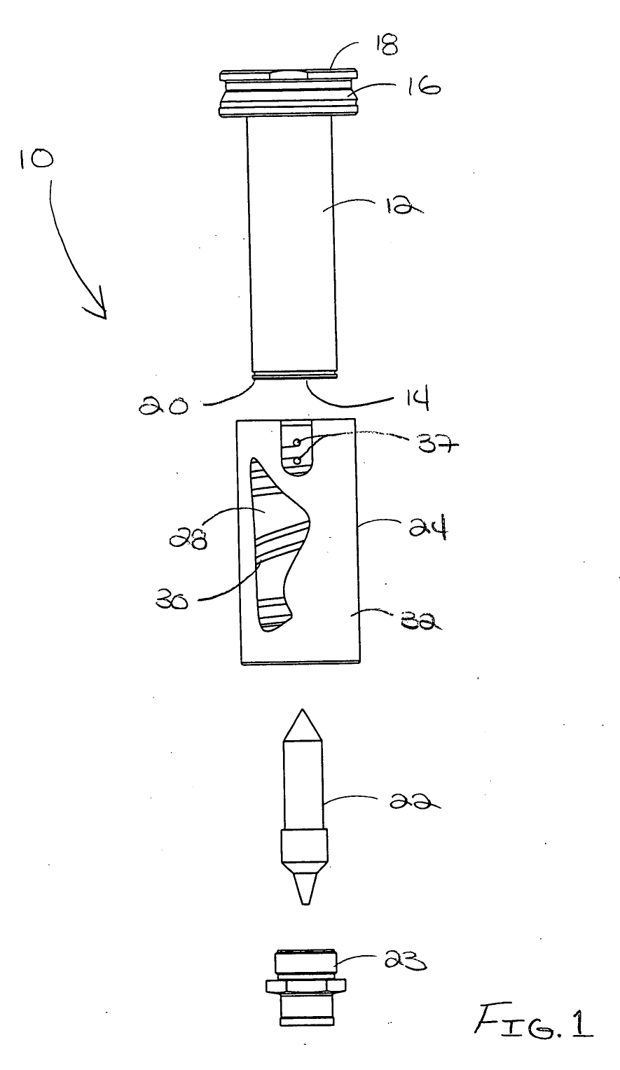

Referring now more particularly to FIG. 1 of the drawings, there is shown an illustrative hot runner bushing 10 in accordance with the present invention. The hot runner bushing 10 is usable for conveying a pressurized melt stream such as fluid plastic material in an injection molding machine. In this case, the illustrated hot runner bushing 10 is particularly designed for conveying a melt stream from a supply source to a gate leading to a mold cavity. However, as will be appreciated by those skilled in the art, the present invention is also applicable in other melt stream conveying components of an injection molding machine. Moreover, the present invention can be used with any desired plastic resin material whether crystalline or amorphous including resins reinforced with glass.

In the illustrated embodiment, the hot runner bushing 10 consists of a cylindrical body 12 having a central flow passageway 14 extending longitudinally through the body 12 for conveying the pressurized melt stream. The hot runner bushing 10 includes an annular flange or head 16 at the inlet or upstream end 18 of the bushing 10 (see, e.g., FIG. 1) through which the melt stream is directed into the bushing. At the outlet or downstream end 20 of the bushing 10, a tip 22 is provided, which in this case is a separate member that is received in the downstream end 20 of the bushing 10 and secured in place via a retaining element 23. The tip 22 has a fluid passageway that communicates with the fluid passageway 14 in the bushing body 10 so that a melt stream directed through the bushing is conveyed into or around the tip. Furthermore, the tip 22 includes one or more exit passageways that direct the melt stream through the gate and into the mold cavity. Depending on the gating requirements of the particular application, the tip 22 can have a variety of different configurations and the present invention is not in any way limited to any particular tip configuration.

For heating the melt stream during its travel through the flow passageway 14 of the bushing body 12, the hot runner bushing 10 includes a heater 24. According to one important aspect of the present invention, one or more components of the heater 24 are thermally sprayed (e.g., flame sprayed or plasma sprayed). Using thermally sprayed components allows the heater 24 to be manufactured in an easier and more cost effective manner as compared to conventional hot runner bushing heaters. Specifically, conventional hot runner bushing heaters require multiple labor-intensive steps to manufacture. In contrast, the use of thermally sprayed components eliminates, for example, the need for swaging as well as manual addition of cement for wire management. The use of thermally sprayed components also enables the heater 24 to have a relatively thin profile as compared to bulky conventional heaters. The reduced profile of the heater 24 makes it less susceptible to condensation and moisture and makes it easier to use with relatively small hot runner components.

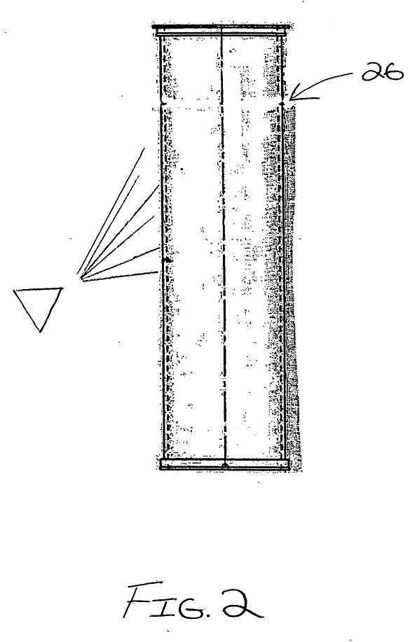

Thermal spraying is a well-known process and, as such, is not described in detail herein. Generally, in a thermal spraying process a powdered material is fed in a carrier gas to a flame spray gun or torch (either arc plasma or gas). The flame spray gun heats the powdered material and the hot powder fuses together and to the substrate to which it is being applied forming a thin coating or layer. The application of the components of the heater of an exemplary embodiment of the present invention is shown diagrammatically in FIG. 2.

The thermally sprayed components of the heater 24 are applied onto a preformed core 26 (see FIG. 2). The preformed core 26 can be a separate cylindrical sleeve that can be arranged over the bushing body 12 as in the illustrated embodiment or the flame sprayed components of the heater 24 could be applied directly to the outer surface of the bushing body 12. Advantageously, the use of a separate element as the core 26 allows the heater 24 to be easily replaced without discarding the entire bushing 10. To allow for efficient heat transfer from the heater 24 to the bushing body 12, the core 26 can be made of any suitable heat conductive material such as, for example, stainless steel.

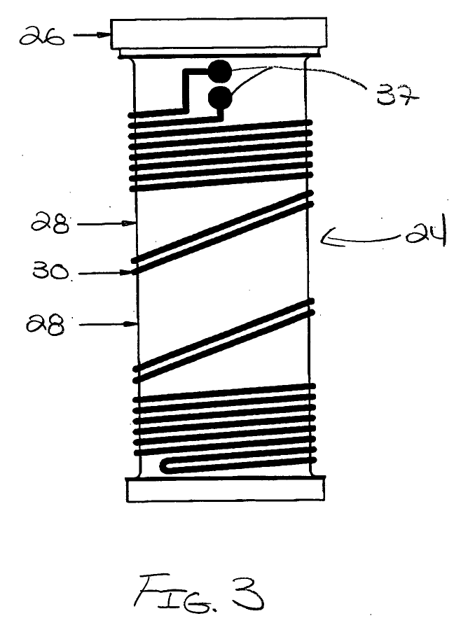

A dielectric substrate layer 28 (see FIGS. 1 and 3) is arranged over the outer surface of the core 26. The dielectric substrate layer 28 consists of a fine powder that is thermally sprayed onto the entire outer surface of the core 26. The thermally sprayed dielectric substrate layer 28 can be between approximately 0.005 inch and 0.030 inch thick. According to preferred embodiments of the invention, the dielectric substrate layer 28 can consist of thermally sprayed aluminum oxide powder or an aluminum oxide-titanium oxide powder blend. In order to increase the adhesion of the dielectric substrate layer 28 to the core 26, a transition layer of flame sprayed ceramic base can be applied to the core 26 before the dielectric substrate layer 28 is applied via thermal spraying.

For producing heat, a thermally sprayed resistance element layer 30 is applied over or on top of the dielectric substrate layer 28 (see FIGS. 1 and 3). In particular, the resistance element layer 30 consists of an electrically conductive powdered material (e.g., nickel chromium or molybdenum-silicon) that is flame sprayed onto the dielectric substrate layer 28. In preferred embodiments of the invention, the resistance element layer 30 can be approximately 0.005 inch to approximately 0.040 inch thick. Unlike the dielectric substrate layer 28, which is generally applied over the entire surface of the core 26, the resistance element layer 30 is generally formed in a discrete pattern or profile on the heater 24 with areas of the heater remaining uncovered. This pattern or profile enables the heat produced by the heater 24 to be concentrated in certain areas of the hot runner bushing 10. For example, in the illustrated embodiment, the resistance element layer 30 is formed in a helical pattern, as best shown in FIG. 3, that concentrates the heat that is produced in areas near either end of the bushing 10.

The resistance element layer 30 can be formed into the desired pattern in at least two different ways. First, the resistance element powder can be flame sprayed over the entire dielectric substrate layer 28. The desired pattern can then be formed by removing the unwanted areas of the resistance element layer 30 such as by micro sandblasting. The removal process can be facilitated through the use of a mask that covers the portions of the resistance element layer 30 needed for the final pattern. Alternatively, a mask with openings in the form of the desired pattern can be used when the resistance element powder is flame sprayed onto the heater 24. When the mask is removed, the resistance element layer 30 will be in the desired pattern. As will be appreciated, the present invention is not limited to any particular method for forming the resistance element layer 30 into the desired pattern.

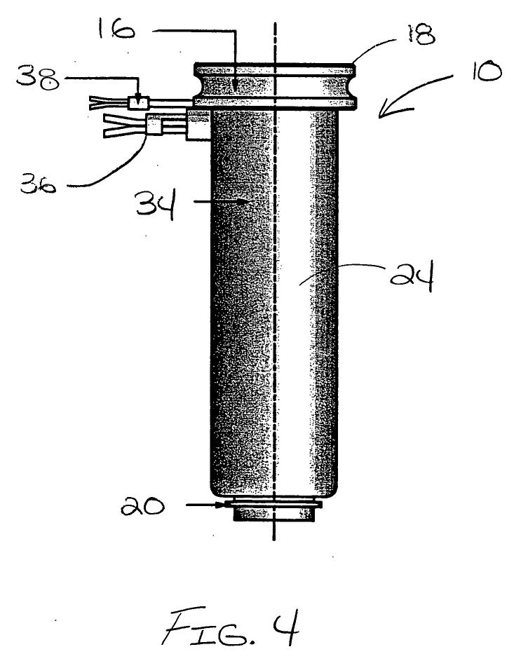

To ensure efficient thermal conductivity, a thermally sprayed dielectric overlay layer 32 is provided over the resistance element layer 30. To form the dielectric overlay layer 32 (shown partially cutaway to expose the resistance element layer in FIG. 1), a dielectric powdered material (e.g., aluminum oxide powder or an aluminum oxide-titanium oxide powder blend) is thermally sprayed over or on the resistance element layer 30. In certain preferred embodiments, the thermally sprayed dielectric overlay layer 32 is approximately 0.005 inch to approximately 0.040 inch thick. As with the initial dielectric substrate layer 28, transition layers can be used between the resistance element layer 30 and the dielectric substrate layer 28 and the resistance element layer 30 and the dielectric overlay layer 32 to help improve the adhesion of the layers. To protect the thermally sprayed components of the heater from damage, the heater can be equipped with an outer shell 34 which overlies the dielectric overlay layer as shown in FIG. 4.

For connecting the resistance element layer 30 to an electrical power source, the heater 24 has leads 36 extending radially through an upper end of the outer shell 34 as shown in FIG. 4. These leads 36 connect to end points 37 of the resistance element layer 30. When applying the dielectric overlay layer 32, these end points 37 should remain uncovered so that the power leads 36 can be attached thereto. In order to sense the temperature of the bushing body 12, a thermocouple 38 extends between the bushing body 12 and heater core 26 to a point approximately midway the axial length of the bushing and has an upstream lead extending from the shell 34 at a location adjacent the heating element leads 36 as shown in FIG. 4. In an alternative embodiment of the invention, the thermocouple 38 also could comprise a thermally sprayed element that is flame or plasma sprayed onto the heater core 26.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A hot runner component for heating and directing fluid material of a melt stream to a mold cavity comprising:
a body having a fluid passageway therein for conveying the melt stream; and
a heater for heating the melt stream as the melt stream passes through the fluid passageway of the body, the heater comprising a core arranged in surrounding relation to the fluid passageway of the body, a thermally-sprayed dielectric substrate layer overlying the core, a thermally-sprayed electrical resistance element layer overlying the dielectric substrate layer, the resistance element layer forming a discrete pattern and a thermally sprayed dielectric overlay layer overlying a substantial portion of the resistance element layer.

2. The hot runner component according to claim 1 wherein the heater further includes an outer shell arranged in overlying relation to the dielectric overlay layer.

3. The hot runner component according to claim 2 wherein the heater includes a pair of leads extending out of the outer shell, each lead being connected to a respective end point of the resistance element layer.

4. The hot runner component according to claim 1 further including a tip arranged at a downstream end of the body, the tip including a fluid passageway that communicates with the fluid passageway in the body.

5. The hot runner component according to claim 1 wherein the discrete pattern of the resistance element layer is a helical pattern.

6. The hot runner component according to claim 1 wherein the dielectric substrate layer comprises a thermally-sprayed aluminum oxide powder.

7. The hot runner component according to claim 1 wherein the dielectric substrate layer comprises a thermally-sprayed aluminum oxide-titanium oxide powder blend.

8. The hot runner component according to claim 1 wherein the resistance element layer comprises a thermally-sprayed nickel chromium powder.

9. The hot runner component according to claim 1 wherein the resistance element layer comprises a molybdenum silicon powder.

10. The hot runner component according to claim 1 wherein the dielectric overlay layer comprises a thermally-sprayed aluminum oxide powder.

11. The hot runner component according to claim 1 wherein the dielectric overlay layer comprises a thermally-sprayed aluminum oxide-titanium oxide powder blend.

12. A method of making a hot runner component for heating and directing fluid material of a melt stream, comprising, in any particular order, the steps of:
thermally spraying a dielectric powder material onto an outer surface of a heater core to form a dielectric substrate layer;
thermally spraying an electric resistance powder material onto the dielectric substrate layer to form an electric resistance element layer, the electric resistance element layer being formed in a discrete pattern;
thermally spraying a dielectric powder material over a substantial portion of the resistance element layer to form an dielectric overlay layer; and
arranging the core in surrounding relation to a fluid passageway extending through a hot runner component body.

13. The method according to claim 12 wherein forming the electric resistance element in a discrete pattern comprises thermally spraying the electric resistance powder material over a substantial portion of the dielectric substrate layer and then removing a portion of the electric resistance powder material from the dielectric substrate layer to form the discrete pattern.

14. The method according to claim 12 wherein forming the electric resistance element in a discrete pattern comprises thermally spraying the electric resistance powder material onto the dielectric substrate layer using a mask having openings in the form of the discrete pattern.

15. The method according to claim 12 wherein the discrete pattern in a helical pattern.

16. The method according to claim 12 further including the step of arranging an outer shell in overlying relation to the dielectric overlay layer.

17. A hot runner component for heating and directing fluid material of a melt stream to a mold cavity comprising:
a body having a fluid passageway therein for conveying the melt stream; and
a heater for heating the melt stream as the melt stream passes through the fluid passageway of the body, the heater comprising a thermally-sprayed dielectric substrate layer overlying the body, a thermally-sprayed electrical resistance element layer overlying the dielectric substrate layer, the resistance element layer forming a discrete pattern and a thermally sprayed dielectric overlay layer overlying a substantial portion of the resistance element layer.

18. The hot runner component according to claim 17 wherein the heater further includes an outer shell arranged in overlying relation to the dielectric overlay layer.

19. The hot runner component according to claim 18 wherein the heater includes a pair of leads extending out of the outer shell, each lead being connected to a respective end point of the resistance element layer.

20. The hot runner component according to claim 17 further including a tip arranged at a downstream end of the body, the tip including a fluid passageway that communicates with the fluid passageway in the body.
